(19) United States
(12) Patent Application Publication
(10) Pub. No.: US 2010/0252540 A1
(43) Pub. Date: Oct. 7, 2010

(54) METHOD AND APPARATUS FOR BRITTLE MATERIALS PROCESSING

(75) Inventors: Weisheng Lei, San Jose, CA (US); Hisashi Matsumoto, Hillsboro, OR (US); Glenn Simenson, Tigard, OR (US); Guangyu Li, Portland, OR (US); Jeffrey Howerton, Portland, OR (US); David Childers, Portland, OR (US); Edward Johnson, Vernonia, OR (US); Jeffrey Albelo, Portland, OR (US)

Correspondence Address: ELECTRO SCIENTIFIC INDUSTRIES, INC., 13900 N.W. SCIENCE PARK DRIVE, PORTLAND, OR, 97229, US

(73) Assignee: ELECTRO SCIENTIFIC INDUSTRIES, INC., Portland, OR (US)

(21) Appl. No.: 12/753,509

(22) Filed: Apr. 2, 2010

Related U.S. Application Data
(63) Continuation of application No. 12/732,020, filed on Mar. 25, 2010.
(60) Provisional application No. 61/164,162, filed on Mar. 27, 2009.

(51) Int. Cl. B23K 26/00

(52) U.S. Cl. 219/121.62

(57) ABSTRACT

An improved method for laser machining features in brittle materials 8 such as glass is presented, wherein a tool path 10 related to a feature is analyzed to determine how many passes are required to laser machine the feature using non-adjacent laser pulses 12. Laser pulses 12 applied during subsequent passes are located so as to overlap previous laser spot locations by a predetermined overlap amount. In this way no single spot receives excessive laser radiation caused by immediately subsequent laser pulses 12 being applied adjacent to a previous pulse location.

Continuation of application Ser. No. 12/732,020 filed on Mar. 25, 2010 which claimed priority from provisional application No. 61/164,162 Mar. 23, 2009.

### TECHNICAL FIELD

The present invention regards methods for laser processing of brittle materials such as glass or ceramic. In particular it regards methods for laser machining complex features in glass or ceramic materials while avoiding stress fractures, chipping and debris and while maintaining acceptable system throughput. Stress fractures, chipping and debris are avoided by laser machining complex features in brittle materials with particular patterns of laser pulses while heatsinking the material which maintains acceptable system throughput.

### BACKGROUND OF THE INVENTION

Brittle material machining has been traditionally realized by using mechanical saws, which scribes the glass and follow with a mechanical breaking step. By brittle materials we mean materials such as glass or glasslike materials including semiconductor substrates such as silicon or sapphire wafers, or ceramic or ceramic-like materials such as sintered aluminum oxide and the like. In recent years, laser technology has been adopted for brittle materials cutting, which generally uses laser as a localized heating source, either accompanied by a cooling nozzle or not, to generate stress and micro cracks along the trajectories to cut the material. Such resultant stress and micro cracks either may be sufficient enough to cause the material to fracture and separate along the designed trajectories or may require a subsequent breaking step to separate the material. Existing technologies utilizing laser only without a cooling source include, but are not limited to MLBA (Multiple Laser Beam Absorption) as described in US patent application No. 2007/0039932 DEVICE FOR SEPARTIVE MACHINING OF COMPONENTS MADE FROM BRITTLE MATERIAL WTH STRESS-FREE COMPONENT MOUNTING, inventors Michael Haase and Oliver Haupt. Feb. 22, 2007 and US patent application No. 2007/0170162 METHOD AND DEVICE FOR CUTTING THROUGH SEMICONDUCTOR MATERIALS, inventors Oliver Haupt and Bernd Lange, Jul. 26, 2007, which uses a near IR laser source in combination with a pair of reflective mirrors to maximize the volume absorption of photon energy in the glass along the path to be separated so that there will be sufficient thermal stress generated as to break the parts without need to apply additional force. This technology, however, does require an initial mechanical notch to function as a pre-crack. The laser generated stress will make the initial crack propagate to form the separation. ZWLDT®: Zero-Width Laser Dicing Technology® by Fonon Technology International, Lake Mary, Fla. 32746, uses a CO₂ source to heat the glass following with a cooling nozzle to generate stress as to initiate micro cracks along the cutting path then apply a mechanical breaking step to separate the glass. All these afore-cited approaches are very difficult to apply to the situation in which the trajectories involve round corners or curved path due to the difficulty in precisely controlling the direction of crack propagation, since there is almost zero kerf width associated with these processes. Even applying a mechanical breaking step it is still very difficult to precisely separate the parts without causing significant chipping or cracking from bulk glass.

In general, these approaches recognize the difficulty in machining complex shapes in brittle materials without either relying on thermal or mechanical cleaving to complete the separation of material. This type of separation can only occur along straight lines and cannot easily machine complex shapes such as curves or rounded corners. If the laser itself is used to cut brittle material without thermal or mechanical assistance, much more laser energy is required for material removal. With brittle materials such as glass or ceramic, removing material solely with laser energy is difficult because delivering multiple laser pulses to the material in rapid sequence in order to completely remove material in a particular area causes problems with chipping and cracking. In order to avoid problems such as cracking and chipping the rate of pulse delivery must be slowed down greatly, thereby reducing system throughput In addition, vaporized, liquefied or particulate material from the laser pulse location on the workpiece is sometimes re-deposited as debris on the workpiece, disturbing subsequent processing steps and reducing esthetic qualities.

What is required then is a method for cutting brittle materials such as glass or ceramic with complex shapes with a laser at acceptable rates without causing unacceptable chipping, cracking or debris.

### SUMMARY OF THE INVENTION

An aspect of the instant invention is a method for laser machining complex patterns or shapes in brittle materials such as glass or ceramic that avoids chipping and cracking in the material associated with excessive heat build up in the region surrounding the feature without requiring expensive additional equipment or causing a significant reduction if system throughput. Excessive heat build up in the region can be avoided by spacing the laser pulses as the feature is being machined so that succeeding laser pulses do not overlap upon the same location as the previous pulse. An embodiment of the instant invention analyzes the tool path associated with a feature to determine how many passes would be required to laser machine the feature into a workpiece given a desired pulse overlap and step size. A tool path is a series of locations on a workpiece that indicate where a laser pulses are to be directed in order to machine the associated feature. A feature may have multiple possible tool paths depending upon the laser parameters used and still create the same feature. This embodiment directs one or more laser pulses to a selected point on the tool path. Then, rather than moving the laser a fraction of a focal spot distance and directing another pulse to the workpiece to achieve the desired overlap, the system steps over a calculated number of potential pulse locations on the tool path and then directs a laser pulse to the workpiece. The system then continues down the tool path, directing laser pulses to the workpiece separated by a calculated number of potential pulse locations until the tool path is exhausted. The system then starts over, directing a laser pulse to the workpiece in a location offset from the first laser pulse location by a fraction of a laser pulse spot distance, thereby achieving pulse overlap without causing excessive heating. The system then indexes by the calculated step size to the next location, which overlaps the next previous laser pulse location by the same overlap offset. The process continues until the entire feature is machined.

A further aspect of this invention is to avoid heat related problems in machining brittle materials by fashioning a special chuck or part holder to sink heat away from the workpiece being machined. This chuck fixtures the brittle workpiece and provides both a heat sink to remove heat from the brittle workpiece as it is being machined but also provides relief to permit material ejected from the laser pulse site to exit the immediate area being machined, thereby reducing debris re-deposit. This chuck accomplishes this by machining areas from the contact surface of the chuck to provide a shallow depression under at least the edges of the feature thereby providing relief for materials ejected from the laser pulse site.

To achieve the foregoing and other objects in accordance with the purposes of the present invention, as embodied and broadly described herein, a method and apparatus is disclosed.

### BRIEF DESCRIPTION OF THE DRAWINGS

FIG. 1 Tool path with one pass of laser processing.

FIG. 2 Tool path with five passes of laser processing.

FIG. 3 Tool path showing completed laser processing.

FIG. 4 Chuck.

FIG. 5 Chuck with workpiece.

FIG. 6 Article.

FIG. 7 Adapted laser processing system.

### DETAILED DESCRIPTION OF PREFERRED EMBODIMENTS

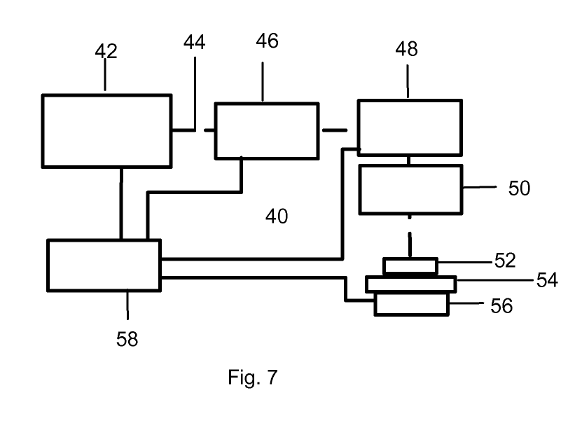

An embodiment of this invention is an improved method for laser machining a feature in brittle material with a laser processing system. This laser processing system has a tool path, or a series of locations on a workpiece that indicate where a laser pulses are to be directed in order to machine the associated feature. An exemplary laser processing system which may be adapted to embody this invention is the MM5800 manufactured by Electro Scientific Industries, Inc., Portland, Oreg. 97229. This system uses two lasers, one or both of which may be a diode-pumped solid state Q-switched Nd:YAG, or Nd:YVO4 laser operating at wavelengths from about 1064 microns down to about 255 microns at pulse repetition frequencies of between 30 and 70 KHz and having average power of greater than about 5.7 W at 30 KHz pulse repetition rate. A diagram of a laser processing system adapted to embody this invention is shown in FIG. 7, where a laser processing system 40 has a laser 42 emitting laser pulses 44 which travel through beam shaping optics 46, beam steering optics 48 and field optics 50 to arrive at a workpiece 52 fixtured on a chuck 54 which is held on a motion stage 56. The motion stage 56 moves the workpiece 52 in relation to the laser pulses 44 under the control of the controller 58, which also controls the laser 42, the beam shaping optics 46 and the beam steering optics 48 to pulse the laser at the appropriate time and rate while coordinating the position of the laser pulses on the workpiece to create the desired features according to aspects of this invention.

Embodiments of this invention represent new applications of techniques disclosed in U.S. Pat. No. 7,259,354 METHODS FOR PROCESSING HOLES BY MOVING PRECISELY TIME LASER PULSES IN CIRCULAR AND SPIRAL TRAJECTORIES, inventors Robert M. Pailthorp, Weisheng Lei, Hisashi Matsumoto, Glenn Simonson, David A. Watt, Mark A. Unrath, and William J. Jordens, Aug. 21, 2007, which is included in its entirety herein by reference, wherein holes are drilled in materials using a laser beam spot size smaller than the hole being drilled, requiring the laser pulses to be moved in a circular or spiral tool path. It was demonstrated that spacing the laser pulses around the circumference of the circle provided better quality holes. This invention is an extension of this disclosure, wherein the quality and throughput of laser machining brittle materials can be increased by calculating the spacing and timing of laser pulses applied to an arbitrary tool path on a brittle workpiece. By spacing the laser pulses from each other in both time and space along the tool path as a feature is machined, excessive heat build up in any particular area is avoided, thereby increasing the quality of the cut. By pulsing the laser according to embodiments of this invention, the location pulsed will be allowed to cool before an adjacent location is pulsed, thereby allowing the laser pulses to maximize the amount of material removed per pulse without having to worry about residual damage. This permits the entire process to be optimized to increase throughput while maintaining quality.

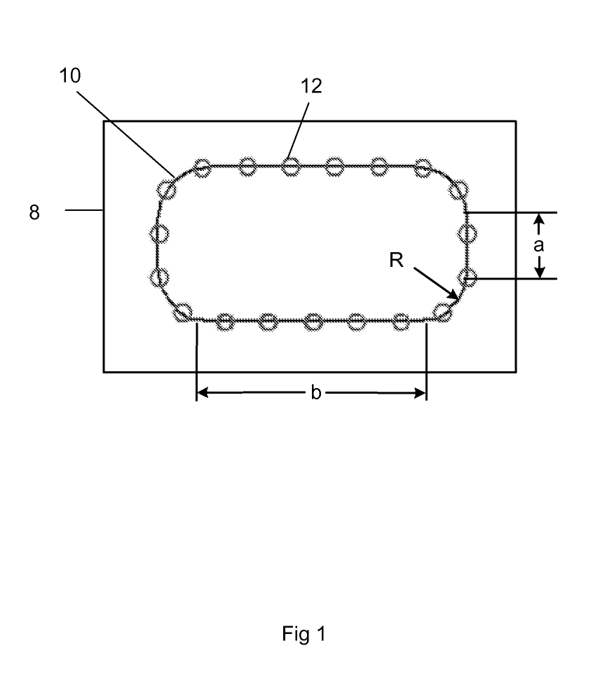

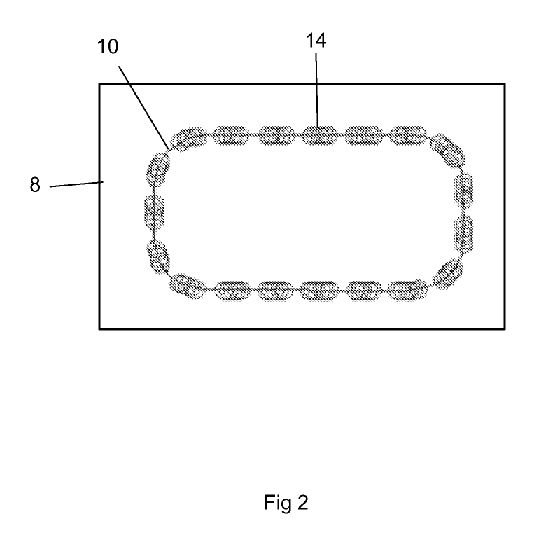

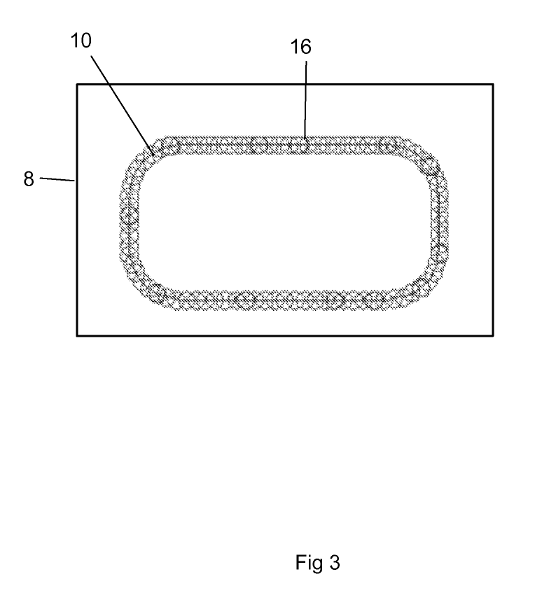

An aspect of this invention is illustrated in FIG. 1, where a complex tool path 10 on a workpiece 8 is shown. This tool path contains curved sections which are difficult to cut without causing cracking and chipping. The circles, one of which is indicated 12, represent laser pulses directed to the workpiece in one pass. Once this pass was complete, the pattern would be indexed one step size and repeated. FIG. 2 shows this pattern of pulses 14 on a tool path 10 on a workpiece 8 after five passes. FIG. 3 shows the laser pulses 16 have completely machined the feature described by the tool path 10 on the workpiece 8.

In laser via drilling applications, when a trepan tool is drilled with multiple repetitions at the perimeter, it is desired to fine tune the scan speed and rep-rate such that pulses are evenly distributed around the perimeter of the hole, in order to achieve uniform material removal and get better via-to-via consistency in terms of via quality. The position increments between pulses should be equal and minimized. A new quantity is defined, the imaginary bite size, which is the distance along the perimeter between the first pulse delivered in the 1st revolution, and the first pulse delivered in the 2nd revolution. An algorithm is specified which tweaks tool velocity to set the imaginary bite size to optimize the pulse spacing to be even and as finely distributed as possible. It is also an aspect of this invention to adjust the timing of the Q switched laser to synchronize all pulses with the timing required by the intended tool path. This is accomplished by synchronizing the signals input to the laser Q switch to cause the laser to pulse at the appropriate moments.

Referring to FIG. 1, note that the rounded rectangle shape of the tool path 10 on the workpiece 8 can be described by the parameters a, b and R as shown on FIG. 1, where a and b are the lengths of the sides and R is the radius of the corner. Laser parameters used to machine this shape according to embodiments of this invention for a rounded rectangle feature in 1.5 mm thick glass with parameters a=200 um, b=50 um and R=50 are given in Table 1 for three different cases. Table 1 shows the pulse repetition frequency (PRF) in kHz, the scan speed of the laser pulses relative to the workpiece, the distance between successive pulses or bite size and the number of repetitions or passes required to machine a rounded rectangle in glass. Note also that an embodiment of this invention can impinge more than one laser pulse at a given location as long as a damage threshold is not exceeded.

TABLE 1

| PRF | Scan Speed | Spot Size | Bite Size | Number of |
|---|---|---|---|---|
| (kHz) | (mm/s) | (um) | (um) | Repetitions |
| 6 | 493.5 | 10 | 82.25 | 10 |

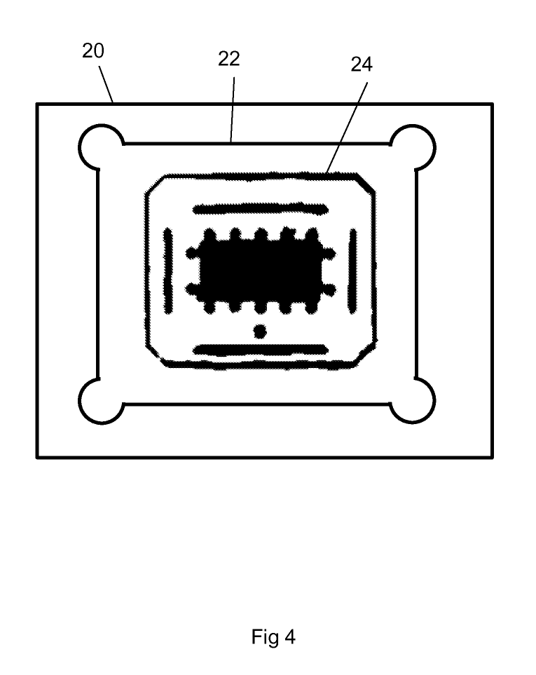

FIG. 4 is an embodiment of this invention wherein a laser processing chuck 20 has a fixturing relief 22 and laser relieves 24 machined into its surface. In this case the chuck is machined from aluminum because of its good heat transfer properties and ease of machining, however, other materials with these properties could be used. Note that the workpiece fixturing on the chuck could be accomplished by other means, including locating pins or vacuum. The laser relieves 24 represent areas under the workpiece which will be receiving through cuts from the laser pulses. By providing relief under through cuts, material ejected from the laser pulse site has room to expand thereby reducing the amount of ejected material impinging upon the workpiece and being re-deposited. The laser relieves 24 are designed to provide relief for through cuts while still maintaining contact between the chuck and the workpiece within a close distance. For instance, for a 1.0 mm hole to be drilled in a workpiece, a relief of 1.5 mm in diameter centered on the hole is machined in the chuck.

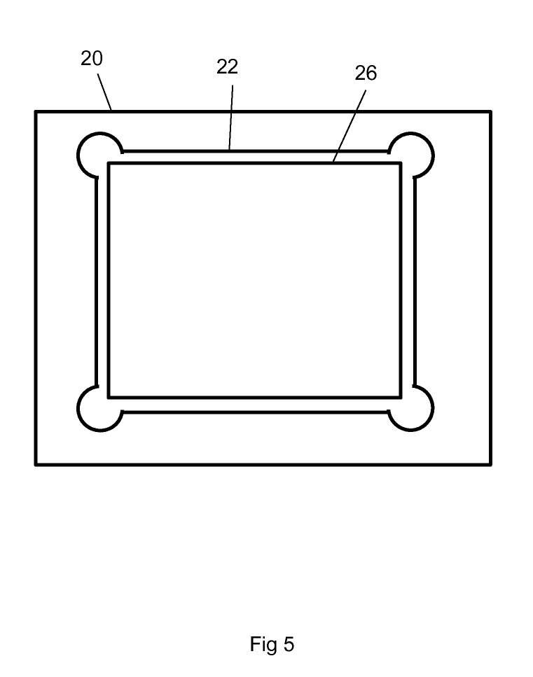

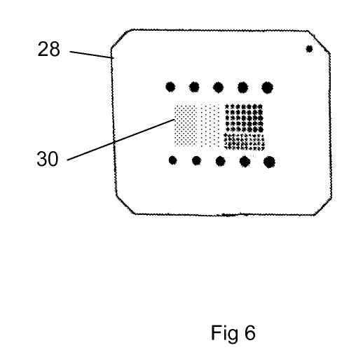

FIG. 5 shows the chuck 20 with fixturing relief 22 with a brittle material workpiece 26 installed in the chuck 20. FIG. 6 shows an article 28 laser machined from a brittle material, in this case alumina, workpiece 26 by an embodiment of this invention (not shown) with groups of holes 30 using chuck 20 and laser parameters as described herein.

FIG. 7 shows an adapted laser processing system 40 adapted to accomplish aspects of this invention. An adapted laser processing system 40 has a laser 42 which may be a solid state or fiber laser emitting pulses 44 with pulse duration ranging from about 10 femtoseconds up to about 1 microsecond at wavelengths ranging from about 255 nm to about 1064 nm at pulse repetition rates ranging from about 1 KHz up to about 100 MHz and with average power ranging from about 4 watts up to about 100 watts. The laser pulses 44 are processed by laser pulse optics 46 which may be a simple optical component such as a lens or much more complex assemblies containing temporal and spatial beam shaping optics depending upon the laser parameters desired. For example, if a Gaussian spatial profile is desired, laser beam optics may include a beam expander. If a shaped beam such as a top hat profile is desired, apertured and/or diffractive optics may be included. The laser pulses 44 are then directed by laser steering optics 48 which may include galvanometers, fast steering mirrors, piezo-electric devices, electro-optical modulators, acousto-optical modulators and the like to direct the laser pulses 44 through optional field optics 50 to the workpiece 52 fixtured on a chuck 54 attached to motion stages 56. Motion stages 56 cooperate with laser 42, laser pulse optics 46, and laser steering optics under the control of controller 58 to direct laser pulses 44 to workpiece 52 according aspects of this invention.

It will be apparent to those of ordinary skill in the art that many changes may be made to the details of the above-described embodiments of this invention without departing from the underlying principles thereof. The scope of the present invention should, therefore, be determined only by the following claims.

We claim:

1. An improved method for laser machining a feature in a brittle workpiece with a laser processing system, said laser processing system having a tool path, comprising:
providing a laser having laser pulses having laser pulse parameters operative to laser machine said brittle material;
calculating a said laser pulse parameters based on said tool path wherein the number and locations of each said laser pulse are calculated to provide predetermined pulse overlap and timing for each said laser pulse; and
directing said laser to emit said laser pulses to impinge upon said brittle material according to said calculated laser pulse parameters, thereby machining said feature in said brittle material.

2. The method of claim 1 wherein said predetermined pulse overlap and timing are selected to provide spacing between said laser pulses.

3. The method of claim 1 wherein said laser parameters include pulse repetition rate, scan speed, spot size, bite size and number of passes.

4. The method of claim 3 wherein said pulse repetition rate is between about 1 KHz and 100 MHz.

5. The method of claim 3 wherein said scan speed is between about 100 mm/s and 5000 mm/s.

6. The method of claim 3 wherein said spot size is between about 10 microns and 100 microns.

7. The method of claim 3 wherein said bite size is between about 10 microns and 500 microns.

8. The method of claim 3 wherein said number of passes is between about 1 and about 100.

9. The method of claim 1 wherein said laser processing system is provided with a chuck fixturing said brittle workpiece and having a relief area adjacent to said features.

10. An improved system for laser machining a feature in a brittle workpiece, comprising:
a laser having laser pulses having laser pulse parameters operative to laser machine said brittle material;
a controller operative to calculate a tool path related to said feature wherein said laser pulse parameters of each said laser pulse are calculated to provide predetermined pulse overlap and timing for each said laser pulse;
laser, laser pulse optics, laser steering optics and motion stages cooperating under the control of said controller to direct said laser pulses to said brittle workpiece according to said tool path and thereby machine said feature in said brittle workpiece.

11. The system of claim 10 wherein said predetermined pulse overlap and timing are selected to provide spacing between said laser pulses.

12. The method of claim 10 wherein said laser parameters include pulse repetition rate, scan speed, spot size, bite size and number of passes.

13. The method of claim 12 wherein said pulse repetition rate is between about 1 KHz and 1 MHz.

14. The method of claim 12 wherein said scan speed is between about 100 mm/s and 5000 mm/s.

15. The method of claim 12 wherein said spot size is between about 10 microns and 100 microns.

16. The method of claim 12 wherein said bite size is between about 10 microns and 500 microns.

17. The method of claim 12 wherein said number of passes is between about 1 and about 100.

18. The system of claim 10 wherein said laser processing system has a chuck fixturing said brittle workpiece and having a relief area adjacent to said feature.
